(19) United States
(12) Patent Application Publication
(10) Pub. No.: US 2023/0014210 A1
(43) Pub. Date: Jan. 19, 2023

(54) Adjustable Wrench

(71) Applicant: Hanlong Industrial Co., Ltd., New Taipei City (TW)

(72) Inventors: Chien-Chou Liao, New Taipei City (TW); Chien-Wei Huang, New Taipei City (TW); Wan-Yu Chiang, New Taipei City (TW)

(21) Appl. No.: 17/498,840

(22) Filed: Oct. 12, 2021

(30) Foreign Application Priority Data
Jul. 13, 2021 (TW) 110125709

(51) Int. Cl. B25B 13/14

(52) U.S. Cl. CPC B25B 13/14

(57) ABSTRACT

An adjustable wrench is disclosed. The adjustable wrench is used for an assembly part. The adjustable wrench includes a frame, an adjustable member, and an engaging element. The adjustable member is adjacent to the frame to form a space between an inner side of the frame, wherein the adjustable member further has a rack. The engaging element is adjacent to the adjustable member and has an engaging portion that meshes with the rack such that, after the adjustable member slides, a position of the engaging portion meshed with the rack is changed so as to change the size of the space; thus, the space can be adjusted to match assembly parts of different specifications.

### BACKGROUND OF THE INVENTION

### 1. Field of the Invention

The present invention relates to an adjustable wrench, and more particularly to an adjustable wrench that can be adjusted conveniently and has an opening which is easily fixed.

### 2. Description of the Related Art

As technology develops, many different types of adjustable wrenches have been developed to match various assembly parts such as nuts or screws of different sizes. Please refer to FIG. 1, which illustrates an operation view of the adjustable wrench of the prior art.

In the prior art, an adjustable wrench 90 which has a movable jaw 91, a stationary jaw 92 and a worm screw 93 has been developed. The movable jaw 91 and the stationary jaw form the shape of an opening. The worm screw 93 and the movable jaw 91 cooperate with each other to adjust the position of the movable jaw 91 so as to change the size of the opening. In this way, the adjustable wrench 90 can be applied to assemble parts N of different sizes.

However, to change the size of the opening of the adjustable wrench 90 in the prior art, the user must continuously rotate the worm screw 93. The worm screw 93 will easily loosen or rotate during use, so the size of the opening is not easy to fix and can easily change. It is not convenient to adjust with only one hand. Thus, the adjustable wrench 90 of the prior art is not sufficiently convenient for the user.

Therefore, it is necessary to invent a new adjustable wrench to mitigate and/or obviate the aforementioned problems.

### SUMMARY OF THE INVENTION

It is a primary object of the present invention to provide an adjustable wrench that can be adjusted conveniently and has an opening which can be easily fixed.

To achieve the above objective, an adjustable wrench of the present invention is used for an assembly part. The adjustable wrench comprises a frame, an adjustable member, and an engaging element. The adjustable member is adjacent to the frame such that it forms a space with an inner side of the frame, wherein the adjustable member further has a rack. The engaging element is adjacent to the adjustable member and has an engaging portion meshed with the rack, wherein after the adjustable member slides, a position of the engaging portion meshed with the rack is changed so as to change the size of the space; thus, the space can accommodate assembly parts of different specifications.

### BRIEF DESCRIPTION OF THE DRAWINGS

FIG. 1 illustrates an operation view of an adjustable wrench of the prior art.

FIG. 2 illustrates a drawing of an adjustable wrench in a first embodiment of the present invention.

FIGS. 3A to 3C illustrate schematic diagrams of the continuous action of the adjustable wrench in the first embodiment of the present invention.

FIG. 4 illustrates a drawing of the adjustable wrench in a second embodiment of the present invention.

FIG. 5 illustrates a cutaway drawing of the adjustable wrench in the second embodiment of the present invention.

FIGS. 6A to 6E illustrate schematic diagrams of the continuous action of the adjustable wrench in the second embodiment of the present invention.

FIG. 7 illustrates a cutaway drawing of the adjustable wrench in a third embodiment of the present invention.

FIG. 8A illustrates a drawing of a first side of the adjustable wrench in the third embodiment of the present invention.

FIG. 8B illustrates a drawing of a second side of the adjustable wrench in the third embodiment of the present invention.

FIG. 9 illustrates a drawing of the adjustable wrench in a fourth embodiment of the present invention.

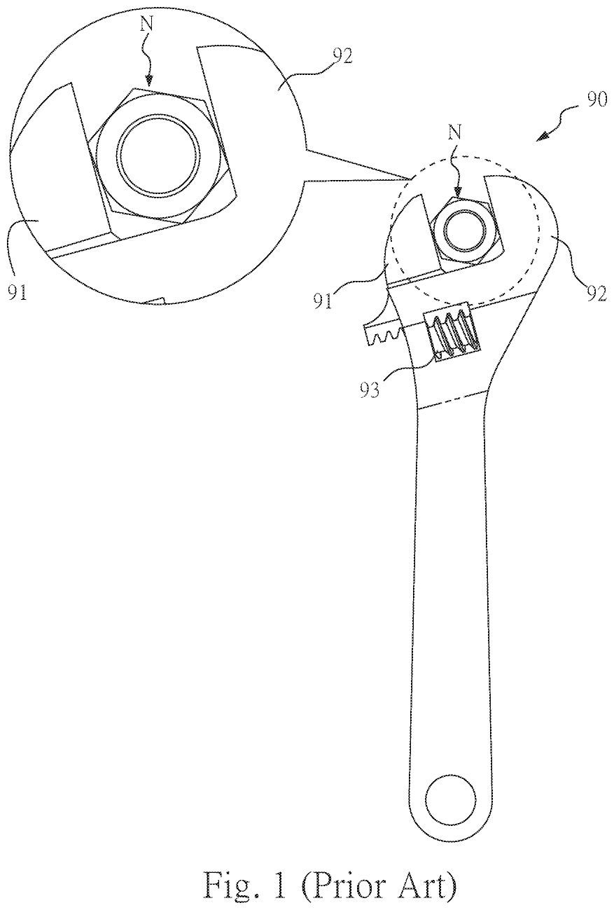

### DETAILED DESCRIPTION OF THE PREFERRED EMBODIMENTS

The advantages and innovative features of the invention will become more apparent from the following detailed descriptions when taken in conjunction with the accompanying drawings.

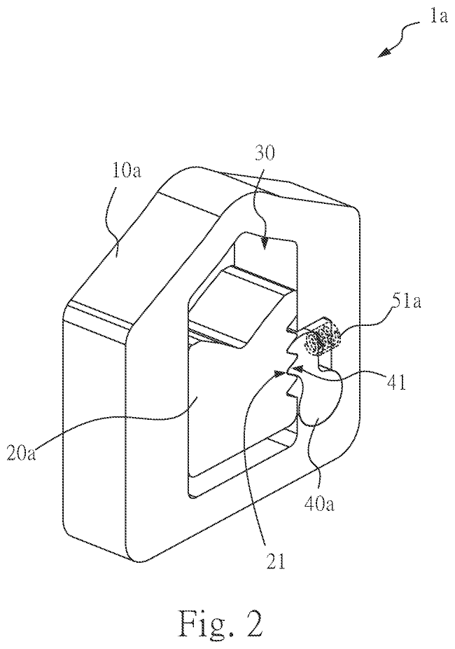

Hereafter, please refer to FIG. 2, which illustrates a drawing of an adjustable wrench in a first embodiment of the present invention.

In the first embodiment of the present invention, the adjustable wrench 1a can be suitable for an adjustable member. The assembly part can be a screw or a nut, and the invention does not limit the type of assembly part. The adjustable wrench 1a comprises a frame 10a, an adjustable member 20a, an engaging element 40a, and a compression spring 51a. The adjustable member 20a is adjacent to the frame 10a and forms a space 30 between the inner side of the frame 10a. The size of the space 30 matches the specifications of the assembly part. When the assembly part is placed into the space 30, at least four sides of the space 30 are in contact with the assembly part. Therefore, when the adjustable wrench 1a rotates, the forces applied to each side of the assembly part can be relatively even and the wear on the assembly part can be greatly reduced.

The adjustable member 20a has a rack 21 such that the engaging element 40a can cooperate with the rack 21. The engaging element 40a is adjacent to the adjustable member 20a. In the first embodiment of the present invention, the engaging element 40a is pivoted on the frame 10a and has an engaging portion 41 which is meshed with the rack 21. The compression spring 51a is connected to the engaging element 40a and one side of the frame 10a so as to provide elastic force for restoring when the engaging element 40a is rotated toward the frame 10a.

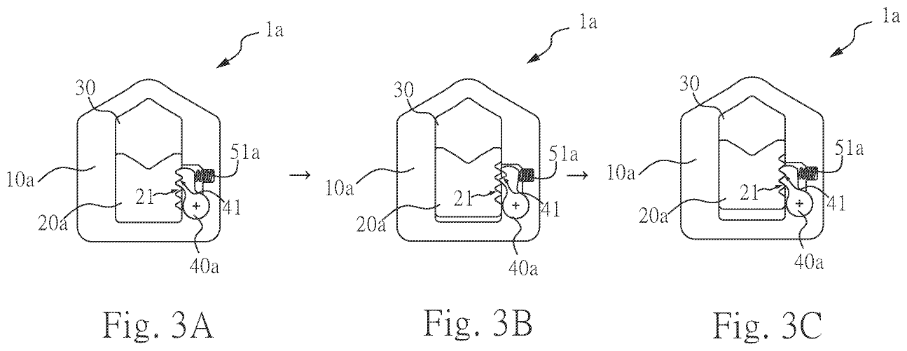

Now please refer to FIGS. 3A to 3C, which illustrate schematic diagrams of the continuous action of the adjustable wrench in the first embodiment of the present invention.

The initial state may be as shown in FIG. 3A. In this state, the engaging portion 41 is meshed with the rack 21. Therefore, the adjustable member 20a will not slide. As shown in FIG. 3B, when the user pushes the adjustable member 20a with one hand to make it slide, the engaging element 40a will be rotated to compress the compression spring 51a. At this time, the engaging portion 41 is separated from the rack 21. In the state shown in FIG. 3C, the adjustable member 20a slides to a position to stop, and the compression spring 51a provides a restoring elastic force again to re-mesh the engaging portion 41 with the rack 21. Therefore, after the adjustable member 20a slides, the position at which the engaging portion 41 meshes with the rack 21 is changed so as to adjust the size of the space 30. In this way, the space 30 can be adjusted to match assembly parts of different specifications.

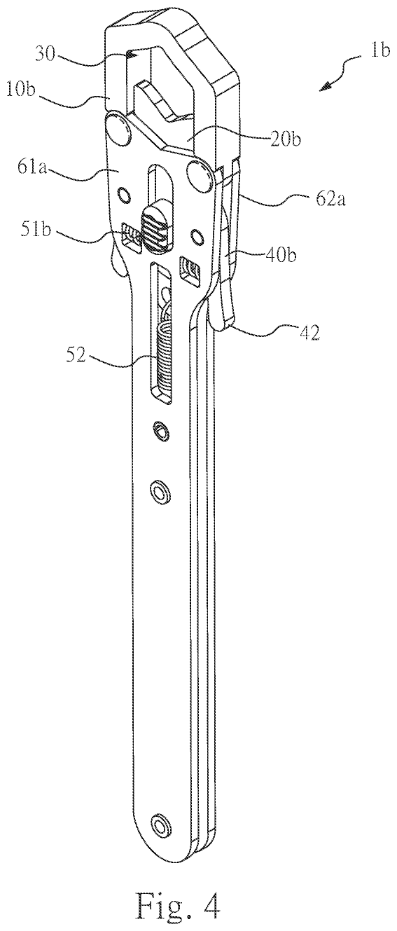

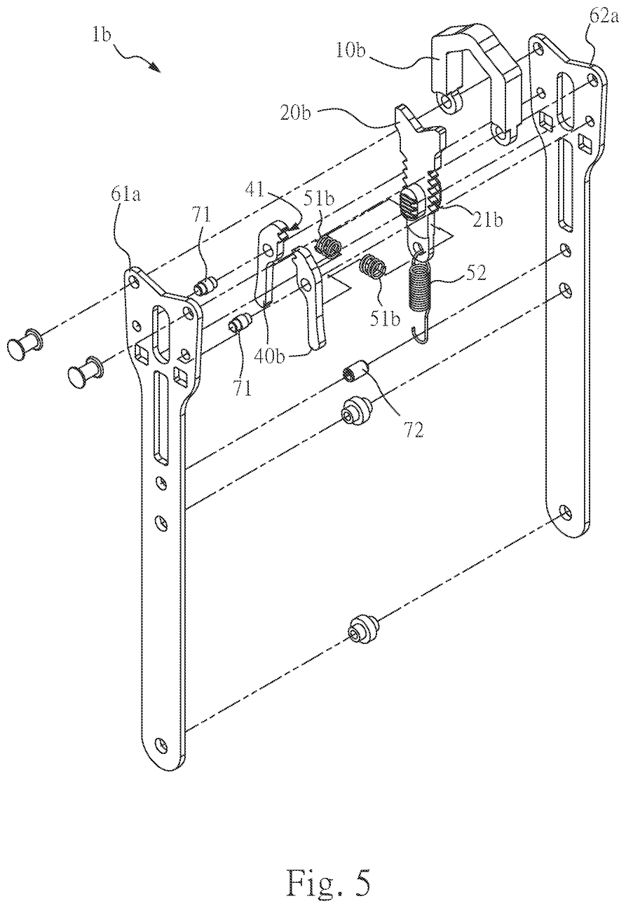

Now please refer to FIG. 4, which illustrates a drawing of the adjustable wrench in a second embodiment of the present invention, and FIG. 5, which illustrates a cutaway drawing of the adjustable wrench in the second embodiment of the present invention.

In the second embodiment of the present invention, the adjustable wrench 1b also includes a frame 10b, an adjustable member 20b, an engaging element 40b, and a compression spring 51b, and it further includes a return spring 52, a first clamp 61a, and a second clamp 62a. The first clamp 61a and the second clamp 62a are used for connecting the frame 10b and clamping the adjustable member 20b. Further, the engaging element 40b is pivoted on a pivot 71 between the first clamp 61a and the second clamp 62a. The shape of the first clamp 61a and the second clamp 62a may be a long handle to facilitate holding by the user, but the present invention is not limited to the present shape.

In the second embodiment of the present invention, the user can directly push the adjustable member 20b with one hand to reduce the size of the space 30. The engaging element 40b can be arranged on the left and right sides of the adjustable member 20b, and the compression spring 51b is connected between the engaging element 40b and one side of the adjustable member 20b. The engaging element 40b further has a pressing portion 42. Thus, after the pressing portion 42 of the engaging element 40b on the left and right sides of the adjustable member 20b is pressed, the engaging element 40b is rotated to separate the engaging element 40b from the adjustable member 20b. In this way, the position where the engaging portion 42 is meshed with the rack 21 can be changed. The compression spring 51b can provide a restoring elastic force to re-mesh the engaging portion 41 with the rack 21. The adjustable wrench 1b further includes a return spring 52, which is connected to the adjustable member 20b and fastened at a fastener 72 between the first clamp 61a and the second clamp 62a. Thus, after the pressing portion 42 of the engaging element 40b is pressed, the engaging element 40b is separated from the adjustable member 20b and the adjustable member 20b is pulled by the return spring 52 to slide back to an initial position.

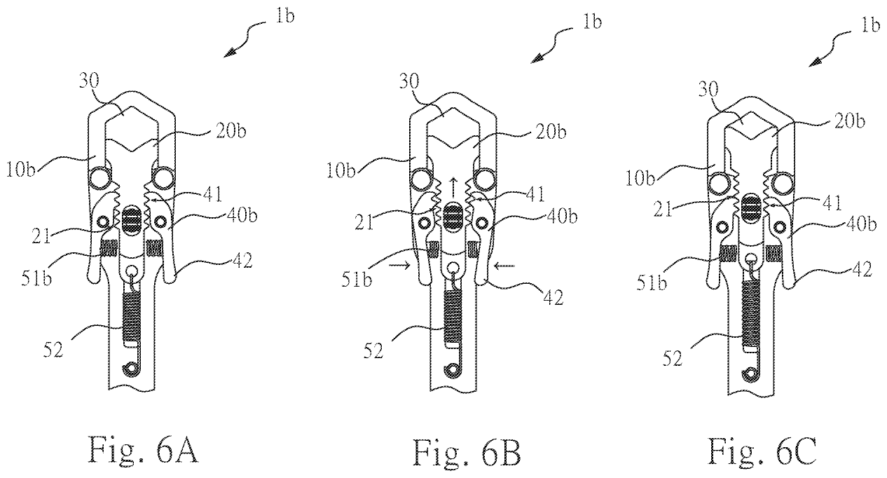

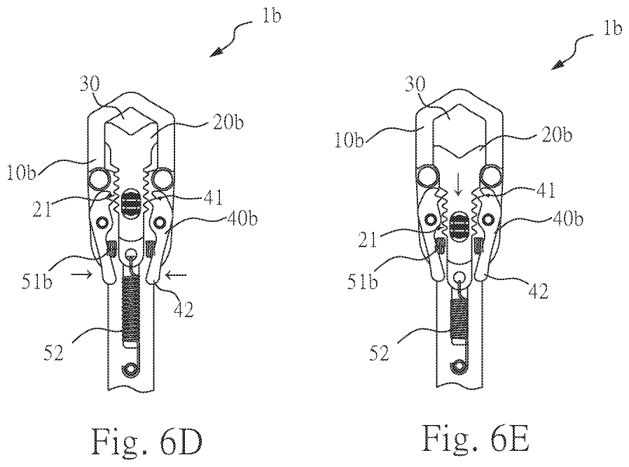

Now please refer to FIGS. 6A to 6E, which illustrate schematic diagrams of the continuous action of the adjustable wrench in the second embodiment of the present invention.

The initial state may be as shown in FIG. 6A. In this state, the engaging portion 41 is meshed with the rack 21. Therefore, the adjustable member 20a will not slide. Then, as shown in FIG. 6B, when the user pushes the adjustable member 20b to make it slide, the engaging element 40b is also rotated due to the sliding of the adjustable member 20b. Then the engaging portion 41 is separated from the rack 21. When the state shown in FIG. 6C is reached, the adjustable member 20b slides to the position and stops. When the user stops pressing the adjustable member 20b, the compression spring 51b provides a restoring elastic force to make the engaging portion 41 re-mesh with the rack 21.

When the state shown in FIG. 6D is reached, the user presses the pressing portion 42 of the engaging element 40b but does not push the adjustable member 20b. At this time, the engaging portion 41 is separated from the rack 21 such that they are not meshed with each other, and the return spring 52 will provide a return elastic force to make the adjustable member 20b slide back to the initial position as shown in FIG. 6E. Therefore, after the pressing portion 42 of the engaging element 40b presses and pushes the adjustable member 20b to slide, the position of the engaging portion 41 meshing with the rack 21 is changed to adjust the size of the space 30. If the pressing portion 42 of the engaging element 40b is pressed but the adjustable member 20b is not pushed, the adjustable member 20b will be moved back to the initial position by the elastic force of the return spring 52. In the first embodiment or the second embodiment of the present invention, the shape of the space 30 can be adjusted to a quadrilateral (as shown in FIG. 6C, FIG. 6D) or a hexagon (as shown in FIG. 6A, FIG. 6B, and FIG. 6E); thus, the applicable assembly specifications are more diverse.

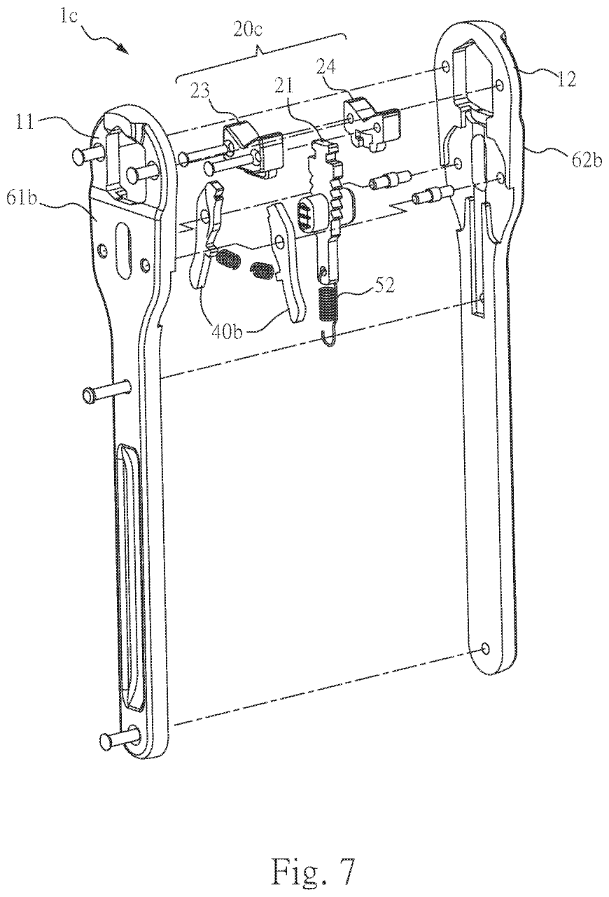

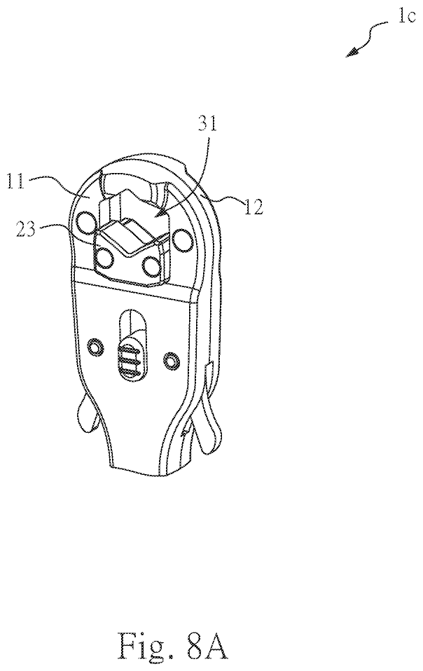

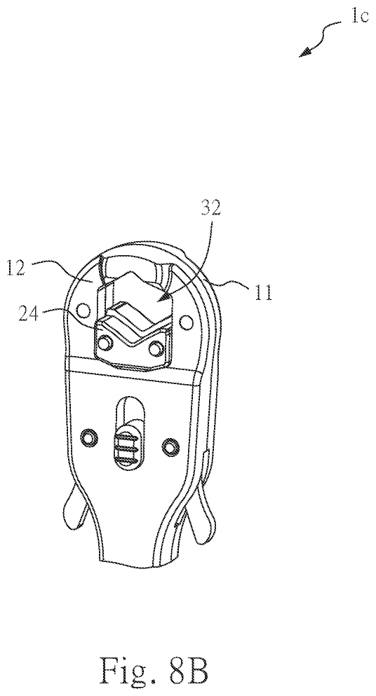

Now please refer to FIG. 7 to FIG. 8B. FIG. 7 illustrates a cutaway drawing of the adjustable wrench in a third embodiment of the present invention, FIG. 8A illustrates a drawing of a first side of the adjustable wrench in the third embodiment of the present invention, and FIG. 8B illustrates a drawing of a second side of the adjustable wrench in the third embodiment of the present invention.

In the third embodiment of the present invention, the adjustable wrench 1c has a first side frame 11 and a second side frame 12. The first side frame 11 is fixed to the first clamp 61b, and the second side frame 12 is fixed to the second clamp 62b. The adjustable member 20c of the adjustable wrench 1c further comprises a main body 22, a first bulge part 23, and a second bulge part 24. The first bulge part 23 is fixed to one side of the main body 22, and the second bulge part 24 is fixed to another side of the main body 22. The space formed by the first bulge part 23 and the first side frame 11 is defined as a first side space 31, as shown in FIG. 8A. The space formed by the first bulge part 24 and the second side frame 12 is defined as a second side space 32, as shown in FIG. 8B. The first bulge part 23 and the second bulge part 24 will have different heights after being disposed on the main body 22; thus, the sizes of the first side space 31 and the second side space 32 will be different. For example, the first side space 31 can be adjusted to match a metric assembly part, and the second side space 32 can be adjusted to match an imperial assembly part. Alternatively, the first side space 31 can be adjusted to match a small-sized assembly part, and the second side space 32 can be adjusted to match a large-sized assembly part, but the present invention is not limited thereto. The adjustable member 20c can also adjust the position to change the size of the first side space 31 and the second side space 32. The adjustment method of the adjustable member 20c in the third embodiment of the present invention is similar to the adjustment method of the adjustable member 20b in the second embodiment, so it is not further described herein. As a result of the above design, the adjustable wrench 1c can be applied to assembly parts with a range of sizes.

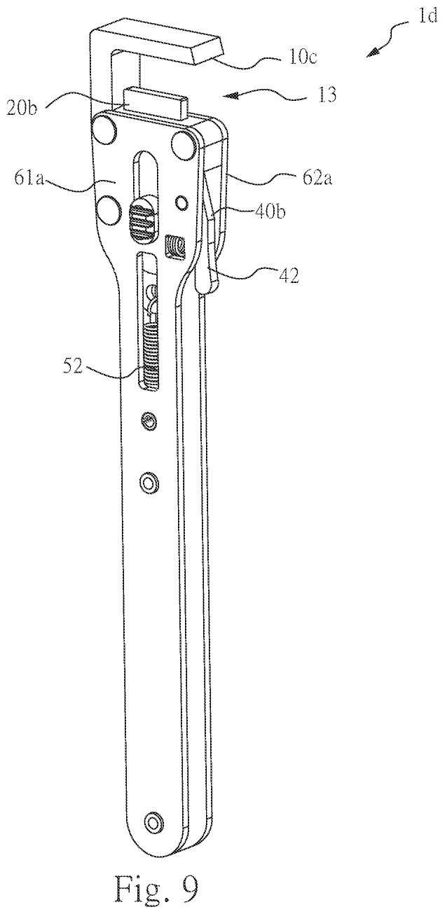

Finally, please refer to FIG. 9, which illustrates a drawing of the adjustable wrench in a fourth embodiment of the present invention.

In the fourth embodiment of the present invention, an opening 13 is disposed on the side of the frame 10c of the adjustable wrench 1d; i.e., the frame 10c is not a completely closed shape, so it can more easily fit the assembly part. The adjustment method adjustable member 20b in the fourth embodiment of the present invention is similar to the adjustment method in the second embodiment, so the description will not be repeated here. As a result of the above design, the adjustable wrench 1c can be applied to a wider range of assembly parts.

In addition to the above-mentioned elements, the adjustable wrenches 1a to 1d of the present invention may also include other elements. Since the technology of other elements is not the focus of the present invention, it will not be further described here. Moreover, the present invention is not limited to the embodiments of the above-mentioned adjustable wrenches 1a to 1d.

It can be seen from the above description that the adjustable wrenches 1a, 1b, 1c, 1d of the present invention can allow the user to easily push the adjustable members 20a, 20b, 20c with one hand to adjust the size of the space 30, the first side space 31 or the second side space 32 to match different assembly parts, and the size of the opening can be easily fixed, so the disadvantages of the prior art can be effectively corrected.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. An adjustable wrench used for an assembly part, the adjustable wrench comprising:
an adjustable member, adjacent to the frame such that it forms a space with an inner side of the frame, wherein the adjustable member further has a rack; and
an engaging element, adjacent to the adjustable member and having an engaging portion meshed with the rack, wherein after the adjustable member slides, a position of the engaging portion meshed with the rack is changed so as to change the size of the space; thus, the space can be adjusted to match assembly parts of different specifications.

2. The adjustable wrench as claimed in claim 1, wherein the engaging element is pivoted on the frame.

3. The adjustable wrench as claimed in claim 2, further comprising a compression spring connected to the engaging member and one side of the frame such that, when the adjustable member slides, the engaging member rotates to compress the compression spring; when the adjustable member stops, the compression spring provides a restoring elastic force to enable the engaging portion to re-mesh with the rack.

4. The adjustable wrench as claimed in claim 1, further comprising a first clamp and a second clamp for connecting the frame and clamping the adjustable member.

5. The adjustable wrench as claimed in claim 4, wherein the engaging member is pivoted on the first clamp and the second clamp by a pivot.

6. The adjustable wrench as claimed in claim 5, wherein the engaging element has a pressing portion.

7. The adjustable wrench as claimed in claim 6, further comprising a compression spring connected to the engaging member and one side of the frame such that, after the pressing part of the engaging member is pressed, the engaging member is separated from the adjustable member such that a position where the engaging portion meshes with the rack can be changed.

8. The adjustable wrench as claimed in claim 6, further comprising a return spring connected to the adjustable piece and connected to the first clamping piece and the second clamping piece by a fastener such that, after the pressing portion of the engaging element is pressed, the engaging element is separated from the adjustable member to enable the adjustable member to slide back to an initial position.

9. The adjustable wrench as claimed in claim 6, wherein:
the frame further comprises:
a first side frame, fastened to the first clamp; and
a second side frame, fastened to the second clamp;
the adjustable member further comprising:
a main body;
a first bulge part, fastened to one side of the main body, wherein the first bulge part and the first side frame constitute a first side space, and a second bulge part, fastened to another side of the main body, wherein the second bulge part and the second side frame constitute a second side space, wherein the sizes of the first side space and the second side space are different.

10. The adjustable wrench as claimed in claim 1, wherein the space is a quadrilateral or a hexagon.

11. The adjustable wrench as claimed in claim 1, wherein one side of the frame has an opening.
